(19) United States
(12) Patent Application Publication
(10) Pub. No.: US 2026/0146781 A1
(43) Pub. Date: May 28, 2026

(54) AIR DUCT ASSEMBLY FOR A REFRIGERATION APPLIANCE AND REFRIGERATION APPLIANCE

(71) Applicants: BSH Hausgeräte GmbH, München (DE); Miele & Cie. KG, Gütersloh (DE)

(72) Inventors: Wenlong CHEN, Chuzhou (CN); Xiupeng CHEN, Nanjing (CN); Liang YUAN, Nanjing (CN); Yunhui WANG, Chuzhou (CN); Jan LAUE, Gütersloh (DE); Jermain REID, Niederkrüchten (DE); Dennis KLEINHANS, Verl (DE)

(21) Appl. No.: 19/387,721

(22) Filed: Nov. 13, 2025

(30) Foreign Application Priority Data
Nov. 27, 2024 (CN) 202411717952.5
Jun. 6, 2025 (CN) 202510757255.0

(51) Int. Cl. F25D 17/04; B01D 35/30; B01D 35/31

(52) U.S. Cl. CPC F25D 17/042; B01D 35/306; B01D 35/31; F25D 2201/10; F25D 2317/04; F25D 2317/067

(57) ABSTRACT

An air duct assembly is provided for a refrigeration appliance having a storage space for items and an air duct conveying air to adjust a temperature of the storage space. The air duct assembly includes an air duct cover separating the storage space from the air duct and having an insertion opening. A filter module is at least partially located in the air duct for filtering air flowing through the air duct, The filter module can be inserted into the air duct from the storage space through the insertion opening in an insertion direction. A filter cover is attached to the air duct cover independently of the filter module by a magnetic connection to close the insertion opening, so that the filter cover can be removed from the air duct cover independently of the filter module, to correctly and conveniently perform maintenance operations. A refrigeration appliance is also provided.

### CROSS-REFERENCE TO RELATED APPLICATION

This application claims the priority, under 35 U.S.C. § 119, of Chinese Patent Applications CN 202411717952.5, filed Nov. 27, 2024, and CN 202510757255.0, filed Jun. 6, 2025; the prior applications are herewith incorporated by reference in its entirety.

### FIELD OF THE INVENTION

The invention relates to the field of household appliances, and in particular to an air duct assembly for a refrigeration appliance and to a refrigeration appliance.

### BACKGROUND OF THE INVENTION

During use, refrigeration appliances face the problem that the stored items may emit odors. The odor of some items is unpleasant and may suffuse the entire storage space of the refrigeration appliance as the air in the refrigeration appliance circulates.

In order to address that problem, a filter may be provided in the refrigeration appliance. The filter is disposed in an air duct of the refrigeration appliance so that an air flow in the air duct can be filtered and purified by passing through the filter. The filter usually requires regular maintenance operations, such as replacing a filter element of the filter. Otherwise, the quantity of the air flow allowed by the filter will decrease over time, and efficiency of the filter will also decrease. That means an increase in costs. In addition, a user faces the problem of inconvenience in operation during the maintenance operation. Since the user is usually inexperienced, the refrigeration appliance may also be damaged due to the user's incorrect operation.

### SUMMARY OF THE INVENTION

It is accordingly an object of the invention to provide an improved air duct assembly for a refrigeration appliance and a refrigeration appliance, which overcome at least one of the hereinafore-mentioned disadvantages and deficiencies of the heretofore-known assemblies and appliances of this general type.

With the foregoing and other objects in view there is provided, in accordance with a first aspect of the invention, an air duct assembly for a refrigeration appliance, wherein the refrigeration appliance includes a storage space for accommodating items to be stored and an air duct for conveying air to adjust a temperature of the storage space. The air duct assembly comprises: an air duct cover for separating the storage space from the air duct, wherein the air duct covers is provided with an insertion opening; a filter module at least partially located in the air duct for filtering the air flowing through the air duct, wherein filter module can be inserted into the air duct from the storage space via the insertion opening in an insertion direction; and a filter cover attached to the air duct cover independently of the filter module by a magnetic connection to close the insertion opening, so that the filter cover can be removed from the air duct cover independently of the filter module.

The invention facilitates ensuring that maintenance operations of the filter module can be performed in a correct and convenient manner. In particular, even inexperienced users can perform maintenance of the filter module correctly and conveniently.

When the maintenance operations for the filter module need to be performed the filter cover may first be removed from the air duct cover independently of the filter module by releasing the magnetic connection. After the filter cover has been removed from the air duct cover, the filter module is taken out via the insertion opening. The filter module can be installed again after undergoing the maintenance operation alone. In the process of installation, the filter module is first inserted into the air duct from the storage space via the insertion opening, and then the filter cover is attached to the air duct cover independently of the filter module by the magnetic connection. By attaching the filter cover to the air duct cover independently of the filter module by the magnetic connection, this series of operations can be conveniently performed and the filter cover can be effectively prevented from being mistakenly involved in the maintenance operation that are only applicable to the filter module.

According to an optional embodiment of the present application, the filter module may be made of a heat-resistant material. The configuration in which the filter cover is attached to the air duct cover independently of the filter module by the magnetic connection is particularly suitable for embodiments in which the filter module is made of the heat-resistant material. After a period of use, the function of the filter module tends to decay or even fail. By a high-temperature treatment, such as by placing the filter module in an oven and baking it for a predetermined time, the filter module can be cleaned and sterilized and its function can be restored. Through the use of the high-temperature treatment, the filter module that has been used for a period of time can be renewed for continued use instead of being discarded or replaced. This high-temperature treatment can effectively renew the filter module and is easy for the user to perform. For example, it can be performed using a household oven without professional equipment or complicated operations.

The filter module can in particular withstand a temperature of 200° C. or more, optionally 220° C. or more, for at least 20 minutes, optionally at least 120 minutes. The user can conveniently use the household oven to bake the filter module. In particular, the filter module can withstand baking in a conventional household oven at the highest temperature that can be set and for the longest baking time that can be set without structural changes and without generating harmful substances.

Compared with the filter module, the filter cover does not need to be made of the heat-resistant material but can be at least partially made of plastic. This facilitates the function of the filter cover and will not increase the difficulty of the maintenance operation of the filter module. Typically, the filter module that performs a filtering function is installed or removed together with the filter cover as a whole. In contrast, the configuration of the present application seems to slightly increase the complexity of the disassembly operation, but it can effectively prevent the user from removing the filter cover and the filter module together and incorrectly putting them into the oven for baking together, thereby preventing the filter cover or the filter module from being damaged due to incorrect operation.

According to an optional embodiment of the present application, the filter module may include a filter element and a container for accommodating the filter element. The container is made of metal.

Optionally, the filter cover includes a front panel made of metal and a back plate made of plastic. The front panel may be located on a side of the back plate facing the storage space and forms a surface of the filter cover facing the storage space. The back plate may separate the front panel from the filter module. With the back plate, the front panel may be separated from the container such that heat transfer between the front panel and the container is hindered. Thus, condensation may be prevented from occurring on the surface of the filter cover facing the storage space.

According to an optional embodiment of the present application, the filter module may include the filter element and the container for accommodating the filter element. The container may include a container body and a container handle, wherein the container body has a container cavity for accommodating the filter element and the container handle is configured in such a manner that the user can grip the container handle to install in place and/or remove the filter module via the insertion opening. Thereby, in the process of the maintenance operation of the filter module, the user's hands can be prevented from being soiled by contacting the container body or the filter element.

Optionally, the container handle may be covered by the filter cover in a direction toward the storage space.

According to an optional embodiment of the present application, the container handle may extend from the container body in the direction toward the storage space. The container handle may extend at least into the opening in the direction toward the storage space. The container handle may extend beyond the air duct cover in the direction toward the storage space. Thus, it can be convenient for the user to operate during installation and removal.

According to an optional embodiment of the present application, the container handle may include a first handle section extending toward the storage space and a second handle section extending downward from the first handle section. An upper surface of the first handle section extends toward the storage space in a downwardly inclined manner. Thereby, condensed water can be prevented from flowing from a surface of the air duct cover facing the storage space to the filter element. Condensed water accumulated at the filter element will reduce the filtering performance of the filter module. Therefore, through the use of the container handle with such a configuration, the filtering performance of the filter module can be improved and the frequency of maintenance required for the filter module can be reduced.

According to an optional embodiment of the present application, the filter cover may be provided on a side facing away from the storage space with a protruding reinforcement structure and a receiving recess recessed relative to the reinforcement structure. The receiving recess extends along a longitudinal direction of the filter cover and is configured to receive a container handle.

Optionally, an interspace is formed between the container handle and the filter cover in the insertion direction.

According to an optional embodiment of the present application, the filter cover may be provided with the protruding reinforcement structure on the side facing away from the storage space. The reinforcement structure extends in the longitudinal direction of the filter cover and is provided with a drainage groove, which extends in a height direction of the refrigeration appliance. Thus, even if the condensed water flows from the surface of the air duct cover facing the storage space via a gap existing between the air duct cover and the filter cover to the rear of the filter cover, it will flow downward through the drainage groove and will not flow to the container.

According to an optional embodiment of the present application, the container handle may include a handle wall, wherein the handle wall is provided with at least two handle openings and a handle bar located between adjacent handle openings. The container handle may also include a wing bent backward from an edge of the handle bar adjoining the handle opening. The container handle with such a shape is convenient for the user to grip and is easy to manufacture.

According to an optional embodiment of the present application, the container may include at least two container bodies and a container handle. Each of the container bodies has a respective container cavity which is separated from the container cavity of the other container body. The container is in particular formed by bending a single sheet. Therefore, the container has a relatively complex structure that can meet the usage requirements (including accommodating multiple filter elements, easy to grip, etc.), and can be manufactured in a cost-effective manner.

For example, the container cavity may have a container opening which opens upwards and via which the filter element can enter the container cavity. The at least two container bodies each include a front wall close to the filter cover, a rear wall opposite to the front wall in the insertion direction and a bottom wall connected between the front wall and the rear wall and opposite to the container opening.

According to an optional embodiment of the present application, the bottom walls of the at least two container bodies may be coplanar and continuous and each of the bottom walls may have a bottom opening respectively. At least one of the at least two container bodies may include a tab bent upward from an edge of its bottom opening adjacent to the adjacent container body. The tab may separate the container cavity of the at least one container body from the container cavity of the adjacent container body. It provides an advantageous implementation of the filtering container, which has a relatively complex structure that can meet the usage requirements and can be manufactured in a cost-effective manner.

According to an optional embodiment of the present application, the container handle may be located between two adjacent container bodies and includes a handle wall, the handle wall being is provided with at least two handle openings and a handle bar located between adjacent handle openings.

In the exemplary embodiments of the present application, the container can be configured to have a relatively complex structure that can meet the usage requirements and is suitable for being formed by bending the single sheet. In addition, the material loss of the sheet used to manufacture the container can be reduced.

For example, the handle wall of the container handle may be coplanar and continuous with the front walls of the two adjacent container bodies.

In particular, a width of the handle wall may be equal to or greater than twice a height of the two adjacent container bodies.

Optionally, the handle wall protrudes downward by a first distance relative to the front walls of the two adjacent container bodies. The handle bar may have a relatively long length, making it easier for the user to grip. The two adjacent container bodies each may have an inner side wall and an outer side wall connected between the front wall and the rear wall and opposite to each other. The inner side wall is adjacent to the container handle and the outer side wall is away from the container handle. The inner side walls of the two adjacent container bodies may be spaced from the front walls by a second distance in the insertion direction. The second distance may be equal to or greater than the first distance. This is particularly helpful in reducing the material loss of the sheet used to manufacture the container while meeting the usage requirements of the container.

According to an optional embodiment of the present application, the filter module may include the filter element and the container for accommodating the filter element. The container may include the container body and a retaining flange, wherein the container body has the container cavity for accommodating the filter element and the retaining flange extends outward from both sides of the container body in a transverse direction perpendicular to the insertion direction and an airflow direction. The air duct cover may be provided with a first groove, into which the retaining flange can be inserted along the insertion direction to retain the filter module in the airflow direction. This is particularly helpful for preventing the filter module from vibrating caused by the air flow.

In particular, a dimension of the first groove measured in the airflow direction decreases along the insertion direction. This helps to reduce the difficulty of installing the filter module.

According to an optional embodiment of the present application, the filter cover may be provided with at least one first magnetic member. The air duct assembly may further include a second magnetic member connected to the air duct cover. The filter cover is attached to the air duct cover by magnetic attraction between the first magnetic member and the second magnetic member.

Optionally, along the insertion direction, the first magnetic member is disposed offset from the filter module. It facilitates exposing the filter module in the air duct as much as possible, so that the air flow in the air duct can pass through the filter module more adequately along an airflow direction perpendicular to the insertion direction.

According to an optional embodiment of the present application, when viewed along the insertion direction, the first magnetic members are disposed on opposite sides of the insertion opening. It contributes to a compact and stable structure of the air duct assembly.

According to an optional embodiment of the present application, the first magnetic member and the second magnetic member may be disposed opposite to each other with the air duct cover interposed therebetween. It helps to strengthen the magnetic attraction.

According to an optional embodiment of the present application, the at least one first magnetic member may at least include two end magnetic members located at both ends of the filter cover and a middle magnetic member disposed centrally relative to the filter cover. The end magnetic members may be disposed perpendicular to the longitudinal direction of the filter cover. The middle magnetic member may be disposed parallel to the longitudinal direction of the filter cover. It facilitates stably attaching the filter cover to the air duct cover.

According to an optional embodiment of the present application, the filter cover may be provided with a protruding reinforcing rib on the side facing away from the storage space. The reinforcing rib extends along the longitudinal direction of the filter cover between the two end magnetic members and the middle magnetic member is located above or below the reinforcing rib. Such a layout can effectively prevent the filter cover from deforming.

According to an optional embodiment of the present application, the first magnetic member may have a middle section close to the second magnetic member, two bent sections extending from both ends of the middle section in the direction toward the storage space and two foot sections extending from ends of the two bent sections away from the middle section in a direction away from each other. A free space may be formed between the surface of the filter cover facing the storage space and the middle section. Such a configuration of the first magnetic member helps to enhance the magnetic attraction effect and facilitates installation.

The first magnetic member is for example an iron plate. Thus, it is easier for the first magnetic member to be formed into a desired shape. Accordingly, the second magnetic member may be a magnet.

According to an optional embodiment of the present application, the filter cover may be provided with a guide protrusion on the side facing away from the storage space. The guide protrusion may have correspondingly a mounting cavity for mounting the first magnetic member on the side facing the storage space. The guide protrusion may have a guide side, which is inclined relative to the insertion direction in a manner that the guide protrusion is narrowed along the insertion direction. On the one hand, the guide protrusion can guide the filter cover to be correctly positioned relative to the air duct cover with the guide side when the filter cover is installed, and on the other hand, it can be used to accommodate the first magnetic member and enable the first magnetic member to be closer to the second magnetic member.

According to an optional embodiment of the present application, the filter cover includes a front panel and a back plate, wherein the front panel is located on the side of the back plate facing the storage space and forms the surface of the filter cover facing the storage space, and wherein the first magnetic member is sandwiched between the front panel and the back plate. It helps to protect the first magnetic member from moisture corrosion.

According to an optional embodiment of the present application, the air duct cover may be provided with a ridge located at a top of the insertion opening and protruding toward a bottom of the insertion opening. The ridge can prevent the condensed water from flowing from the surface of the air duct cover facing the storage space to the filter module, especially the filter element.

The ridges may extend transversely to the insertion direction and transversely to the height direction of the refrigeration appliance, thereby effectively blocking water flow that flows toward the filter module, in particular the filter element, substantially along the insertion direction.

The ridge may, for example, have a front blocking surface facing the storage space, which is perpendicular to the insertion direction. It facilitates guiding the condensed water to drip downwards and preventing the condensed water from continuing to flow backwards.

The ridge may, for example, have a bottom blocking surface, which extends in an upwardly inclined manner from the front blocking surface of the ridge in the direction away from the storage space. The inclination angle of the bottom blocking surface is optionally between 0.1° and 5°, for example 1°. Thus, it is possible to effectively prevent the condensed water from flowing backward toward the filter element along the bottom blocking surface. The ridge is particularly closer to the storage space than the filter element of the filter module.

According to an optional embodiment of the present application, the filter cover may protrude relative to the air duct cover in the direction toward the storage space. Thus, the removal of the filter covert can be facilitated.

Optionally, at least one side surface of the filter cover may extend obliquely toward the air duct cover, so as to form a gripping space between the at least one side surface and the surface of the air duct cover facing the storage space. The gripping space may be covered by the filter cover in the direction toward the storage space. The user's hand can enter the gripping space to remove the filter cover. In the installed state, the gripping space will not be visible to the user. Thus, the filter cover that is easy to remove can be provided with a simple structure.

According to an optional embodiment of the present application, the air duct cover may be provided with a mounting groove on the side facing the storage space. The mounting groove may include a groove bottom face facing the storage space and a groove side face surrounding the groove bottom face. The insertion opening is formed at the groove bottom face. The groove side face is particularly inclined relative to the insertion direction in a manner that the mounting groove is narrowed along the insertion direction. The inclined groove side face can be used to guide the correct installation of the filter cover.

According to an optional embodiment of the present application, the air duct cover may have a support frame on the side facing away from the storage space. The support frame may define an accommodation space for the filter module, and the filter module may be installed in the accommodation space via the insertion opening. The support frame can support and retain the filter module.

According to an optional embodiment of the present application, the support frame may include two partitions extending from both sides of the accommodation space toward the middle in the transverse direction perpendicular to the insertion direction and the airflow direction, such that the accommodation space is divided into a middle portion located between the two partitions in the transverse direction, first grooves located above the partitions, and second grooves located below the partitions. Through the use of the partitions that are simple and easy-to-fabricate, the accommodation space can be divided into multiple portions with various functions. The middle portion can be used to receive the container body and the filter element of the filter module. The first grooves can be used to retain the filter module. The second grooves can be used to retain the air duct cover. During installation, a part of the filter cover can extend into the second grooves and engages therewith to achieve the retaining function.

According to an optional embodiment of the present application, the insertion opening has transverse spaces on both sides of the filter module in the transverse direction perpendicular to the insertion direction, to allow a hand to reach into the transverse spaces to grip the filter module.

Optionally, the filter cover is provided with a retaining protrusion extending in a direction away from the storage space, wherein the retaining protrusion is inserted into the transverse space to retain the filter cover in the transverse direction. These multi-functional transverse spaces contribute to a more compact structure.

According to an optional embodiment of the present application, the filter cover includes a heat insulator, which is located on a side of the filter cover facing away from the storage space and separates the filter module from the storage space. The heat insulator particularly abuts against the air duct cover and closes the insertion opening.

According to an optional embodiment of the present application, the air duct assembly may include an air duct heat insulator located between the air duct cover and the air duct. The air duct heat insulator is provided with a mounting opening, within which the filter module is at least partially located.

The air duct heat insulator may be provided with an air guiding surface adjacent to the mounting opening and facing the air duct, wherein the air guiding surface is inclined toward the storage space in a direction toward the filter module. Through the use of the air guiding surface, more air can pass through the filter element.

With the foregoing and other objects in view, there is concomitantly provided, according to a second aspect of the present invention, a refrigeration appliance, comprising a storage space for accommodating items to be stored, an air duct for conveying air to adjust a temperature of the storage space, and an air duct assembly according to an embodiment of the present application.

Other features which are considered as characteristic for the invention are set forth in the appended claims.

Although the invention is illustrated and described herein as embodied in an air duct assembly for a refrigeration appliance and a refrigeration appliance, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE FIGURES

FIG. 1 is a diagrammatic, perspective view of a refrigeration appliance according to an exemplary embodiment of the present application;

FIG. 2 is a diagrammatic, partial, cross-sectional view of the refrigeration appliance taken along the section line A-A in FIG. 1;

FIG. 3 and FIG. 4 are diagrammatic, perspective views of an air duct assembly from different perspectives;

FIG. 5 and FIG. 6 are exploded, perspective views of the air duct assembly;

FIG. 7 is a partial, enlarged, sectional view of a portion of the air duct assembly circled in FIG. 2;

FIG. 8A is a diagrammatic, perspective view of a container of the air duct assembly according to an exemplary embodiment of the present application;

FIG. 8B is a diagrammatic, plan view of a sheet for manufacturing the container in an exemplary embodiment according to the present application;

FIG. 9 is a diagrammatic, partial, enlarged view of a portion circled in FIG. 7;

FIG. 10 is a diagrammatic, perspective view of an air duct cover of the air duct assembly according to an exemplary embodiment of the present application;

FIG. 11 is a diagrammatic, exploded, perspective view of the air duct cover according to an exemplary embodiment of the present application;

FIG. 12 and FIG. 13 are diagrammatic, partial, cross-sectional views of the air duct assembly according to an exemplary embodiment of the present application taken along section lines B-B and C-C, respectively, of FIG. 1;

FIG. 14 is a diagrammatic, exploded, perspective view of the air duct assembly according to an exemplary embodiment of the present application;

FIG. 15 is a diagrammatic, partial, cross-sectional view of the air duct assembly according to an exemplary embodiment of the present application;

FIG. 16A is a diagrammatic, perspective view of the container of the air duct assembly according to an exemplary embodiment of the present application;

FIG. 16B is a diagrammatic, plan view of a sheet for manufacturing the container in an exemplary embodiment according to the present application;

FIG. 17 is a diagrammatic, exploded, perspective view of the filter cover of the air duct assembly according to an exemplary embodiment of the present application;

FIGS. 18 and 19 are diagrammatic, exploded, perspective views of the air duct assembly according to an exemplary embodiment of the present application from different perspectives;

FIG. 20 is a diagrammatic, partial, cross-sectional view of the air duct assembly;

FIG. 21 is a diagrammatic, perspective view of a portion of the air duct assembly;

FIG. 22 is another diagrammatic, partial, cross-sectional view of the air duct assembly; and

FIGS. 23 and 24 are respective, diagrammatic, perspective and exploded, perspective views of a filter cover of the air duct assembly according to an exemplary embodiment of the present application.

### DETAILED DESCRIPTION OF THE INVENTION

The present application will be further described in detail below in conjunction with the accompanying drawings and exemplary embodiments in order to make the technical problems to be solved by the present application, technical solutions and beneficial technical effects clearer. It should be understood that the specific embodiments described herein are merely illustrative of the application and are not intended to limit the scope of the application.

First, for ease of understanding, referring back to the description in the background, the refrigeration appliance in the related art has problems of increased cost for eliminating odors, inconvenience in user operation and is easy to damage.

For at least one of the foregoing technical problems or another possible technical problem, an exemplary embodiment of the present application provides an air duct assembly for a refrigeration appliance, wherein the refrigeration appliance includes a storage space for accommodating items to be stored and an air duct for conveying air to adjust a temperature of the storage space. The air duct assembly includes: an air duct cover for separating the storage space from the air duct, wherein the air duct cover is provided with an insertion opening; a filter module at least partially located in the air duct for filtering the air flowing through the air duct, wherein the filter module can be inserted into the air duct from the storage space via the insertion opening in an insertion direction; and a filter cover attached to the air duct cover independently of the filter module by a magnetic connection to close the insertion opening, so that the filter cover can be removed from the air duct cover independently of the filter module.

In order to better understand the present application, exemplary embodiments of the present application will be described below with reference to the accompanying drawings.

Before providing detailed descriptions, it should be noted that the directional terms used in the descriptions refer to a conventional use state of the refrigeration appliance, which is for ease of description and should not be understood as absolute limitations on corresponding features. In some drawings, arrows are schematically shown to indicate a height direction H, a width direction W and a depth direction D that are perpendicular to each other.

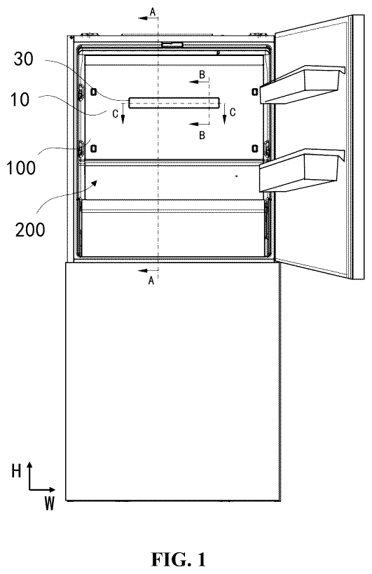

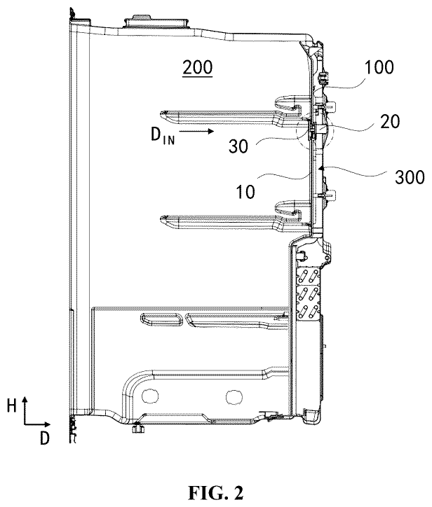

Referring now to the figures of the drawings in detail and first, particularly, to FIG. 1 thereof, there is seen a diagrammatic illustration of a refrigeration appliance according to an exemplary embodiment of the present application, and FIG. 2 diagrammatically shows a partial cross-sectional view of the refrigeration appliance taken along the section line A-A in FIG. 1. In this embodiment, the refrigeration appliance may be implemented as a combined refrigerator with a refrigerating chamber and a freezing chamber, for example. Those skilled in the art will understand that the present application is also applicable to a refrigerator of another type, such as a single refrigerator or freezer. In addition, according to requirements, the application may also be applied to another household refrigeration appliance other than the refrigerator, such as a wine cooler. The present application is particularly applicable to household refrigeration appliances.

As shown in FIG. 1 and FIG. 2, the refrigerator includes a storage space 200 for accommodating items to be stored, which can be surrounded by a housing of the refrigeration appliance. The storage space 200 can be used as a refrigerating chamber, a freezing chamber or a variable-temperature chamber.

The refrigerator is further provided with an air duct assembly 100 and an air duct 300 for conveying air to adjust a temperature of the storage space 200. For example, the air duct 300 can be used to supply cooling air to the storage space 200, thereby reducing the temperature in the storage space 200. Alternatively, the air duct 300 can be used as a return air duct.

In this embodiment, the air duct assembly 100 is disposed adjacent to a rear wall of the housing and is substantially perpendicular to the depth direction D. The air duct assembly 100 may also be disposed elsewhere, such as adjacent to a side wall of the housing.

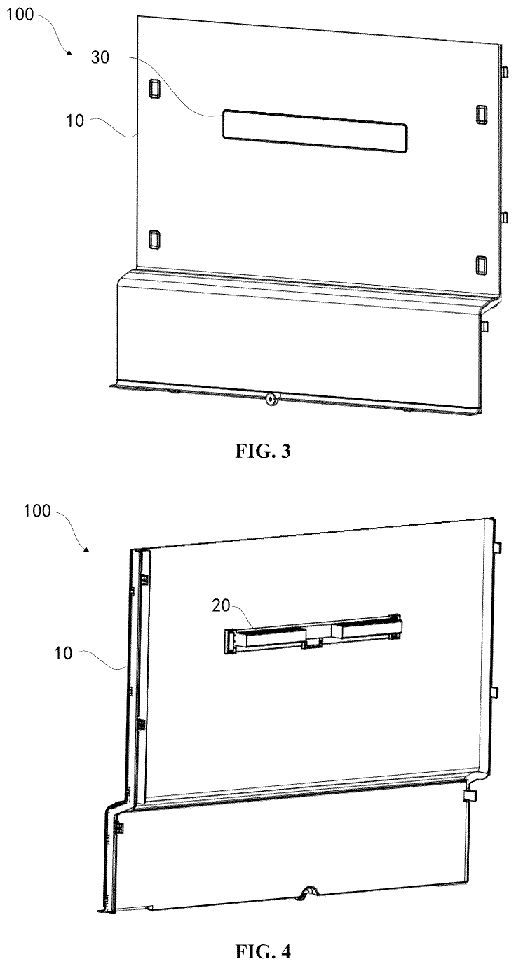

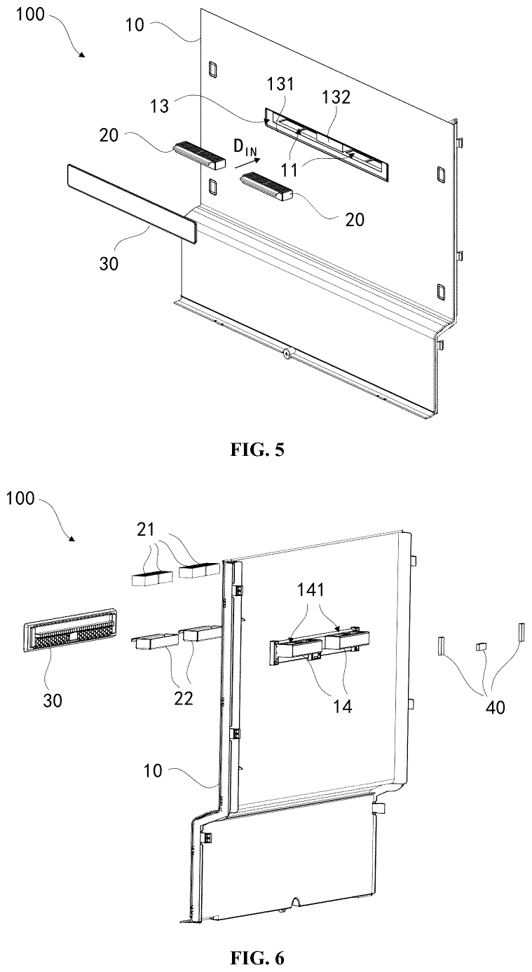

FIG. 3 and FIG. 4 diagrammatically show perspective views of the air duct assembly 100 from different perspectives; FIG. 5 and FIG. 6 diagrammatically show exploded views of the air duct assembly 100.

It can be seen that the air duct assembly 100 includes: an air duct cover 10 for separating the storage space 200 and the air duct 300, wherein the air duct cover 10 is provided with an insertion opening 11; a filter module 20 at least partially located in the air duct 300 for filtering air flowing through the air duct 300, wherein filter module 20 can be inserted into the air duct 300 from the storage space 200 via the insertion opening 11 in an insertion direction; and a filter cover 30 attached to the air duct cover 10 independently of the filter module 20 by a magnetic connection to close the insertion opening 11, so that the filter cover 30 can be removed from the air duct cover 10 independently of the filter module 20.

In the process of disassembly, the filter cover 30 is first removed from the duct cover 10 independently of the filter module 20 by releasing the magnetic connection. After the filter cover 30 has been removed from the duct cover 10, the filter module 20 is then taken out via the insertion opening 11. The filter module 20 can be installed again after undergoing a maintenance operation alone. In the process of installation, the filter module 20 is first inserted into the air duct 300 from the storage space 200 via the insertion opening 11, and the filter cover 30 then is attached to the duct cover 10 independently of the filter module 20 by the magnetic connection.

It helps to ensure that the maintenance operation of the filter module can be performed in a correct and convenient manner. In particular, even inexperienced users can perform the maintenance of the filter module correctly and conveniently.

Such a configuration is particularly suitable for embodiments in which the filter module 20 is made of a heat-resistant material. “The filter module is made of a heat-resistant material” means that the filter module 20 will not change in structure and will not generate harmful substances when subjected to high temperatures. However, it should be understood that this does not mean that the filter module 20 is a single piece made of the same heat-resistant material. Instead, the filter module 20 may include at least one component(s) that is/are a heat-resistant component/heat-resistant components. In other words, the filter module 20 only includes the heat-resistant component/heat-resistant components.

After being used for a period of time, the function of the filter module 20 tends to decay or even fail. By applying a high temperature treatment, such as by placing the filter module 20 in an oven for a predetermined time, the filter module 20 can be cleaned and sterilized and its function can be restored. The filter module 20 can for example withstand a high temperature of 120° C. to 300° C., optionally 150° C. to 300° C., for 20 minutes to 120 minutes, optionally 30 minutes to 90 minutes, to restore its function. The filter module 20 that has been used for the period of time can be renewed for continued use by the high temperature treatment instead of being discarded or replaced.

The filter module 20 can withstand temperatures of 200° C. or more, optionally 220° C. or more, for at least 20 minutes, optionally at least 120 minutes. For this purpose, the user can conveniently use a household oven to bake the filter module 20. In particular, the filter module 20 can withstand baking in a conventional household oven at the highest temperature that can be set for the longest baking time that can be set without structural changes and without generating harmful substances.

Compared with the filter module 20, the filter cover 30 does not have to be made of the heat-resistant material. The filter cover 30 is, for example, at least partially made of plastic. For another example, the filter cover 30 may include a heat insulating foam.

Since the filter cover 30 is attached to the air duct cover 10 independently of the filter module 20 by the magnetic connection, the filter cover 30 and the filter module 20 must be removed from the air duct cover 10 separately. In this way, it is prevented that the user removes the filter cover 30 and the filter module 20 together and mistakenly puts them into the oven for baking together. Conventionally, the filter module 20 that performs a filtering function is installed or removed together with the filter cover 30 as a whole. In contrast, the configuration of the present application seems to slightly increase the complexity of the disassembly operation, but it can effectively prevent the filter cover 30 or the filter module 20 from being damaged due to incorrect operation.

In other embodiments, the filter module 20 may be renewed by other operations, such as by ultraviolet irradiation or by soaking in a disinfectant liquid.

As shown in FIG. 5, the air duct cover 10 may be provided with a mounting groove 13 on a side facing the storage space 200 wherein the mounting groove 13 includes a groove bottom face 131 facing the storage space 200 and a groove side face 132 surrounding the groove bottom face 131. The insertion opening 11 may be formed at the groove bottom face 131. The air duct cover 10 may be provided with two insertion openings 11, for example. Two filter modules 20 may be respectively inserted from the side of the air duct cover 10 facing the storage space 200 along the insertion direction D_{IN} via the two insertion openings 11, so as to be installed in the air duct 300. The insertion direction D_{IN} is substantially perpendicular to a main plane of the air duct cover 10. The two insertion openings 11 may be closed by the same filter cover 30. In this case, the filter cover 30 may have a relatively long longitudinal dimension. A “longitudinal direction” of an object in this context is intended to mean, in particular, a direction which runs parallel to the longest edge of the smallest imaginary cuboid which only just fully encloses the object. A “main plane” of an object in this context is intended to mean, in particular, a plane which is parallel to the biggest surface of the smallest imaginary cuboid which only just fully encloses the object.

As shown in FIG. 6, the air duct cover 10 may have a support frame 14 on a side facing away from the storage space 200 which defines an accommodation space 141 for the filter module 20. The filter module 20 can be installed in the accommodation space 141 via the insertion opening 11. The support frame 14 can support the filter module 20 from below and retain the filter module 20 from above and from the side. In this embodiment, the support frame 14 is formed integrally with a main body of the air duct cover 10.

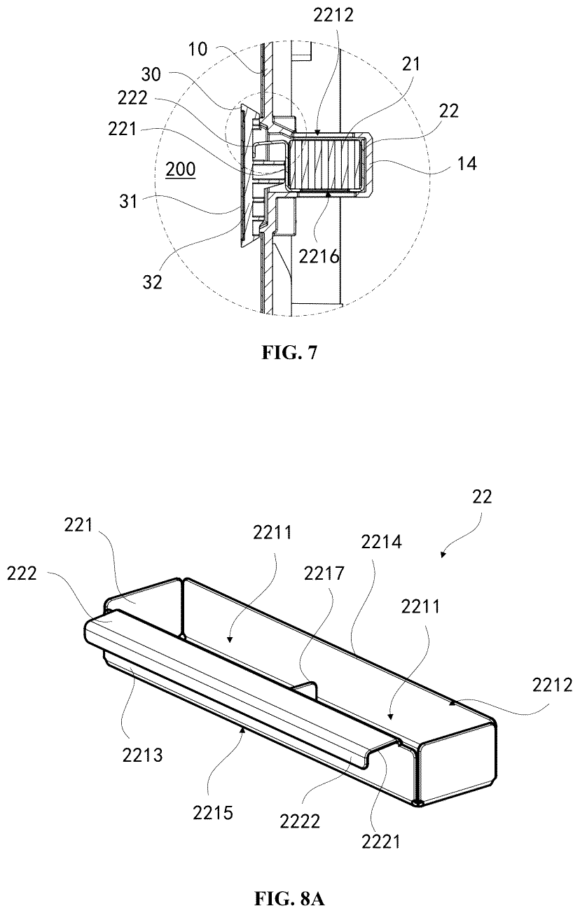

In conjunction with FIG. 7, the air duct assembly 100 according to an exemplary embodiment of the present application is further described below. FIG. 7 diagrammatically shows a partial enlarged view of the portion of the air duct assembly 100 circled in FIG. 2.

In this embodiment, the filter module 20 may include a filter element 21 and a container 22 for accommodating the filter element 21. Optionally, the container 22 is made of metal, for example stainless steel, in particular 304 stainless steel.

The filter cover 30 may include a front panel 31 made of metal and a back plate 32 made of plastic. The front panel 31 is located on a side of the back plate 32 facing the storage space 200 and forms a surface of the filter cover 30 facing the storage space 200, and the back plate 32 separates the front panel 31 from the filter module 20. With the back plate 32 made of plastic, the front panel 31 can be separated from the container 22 so that heat transfer between the front panel 31 and the container 22 is hindered. Thus, condensation can be prevented from occurring at the surface of the filter cover 30 facing the storage space 200.

In other embodiments, the filter cover 30 may have other configurations. For example, the front panel 31 may be made of plastic. Or the filter cover 30 may be formed as an integral piece.

In the installed state, the filter module 20 may contact the filter cover 30. The filter cover 30 may prevent the filter module 20 from moving toward the storage space 200. However, the filter module 20 is not combined with the filter cover 30 into a whole by welding, bonding, thread connection or snap connection, etc.

In other embodiments, the filter module 20 may be neither connected to the filter cover 30 nor in contact with the filter cover 30.

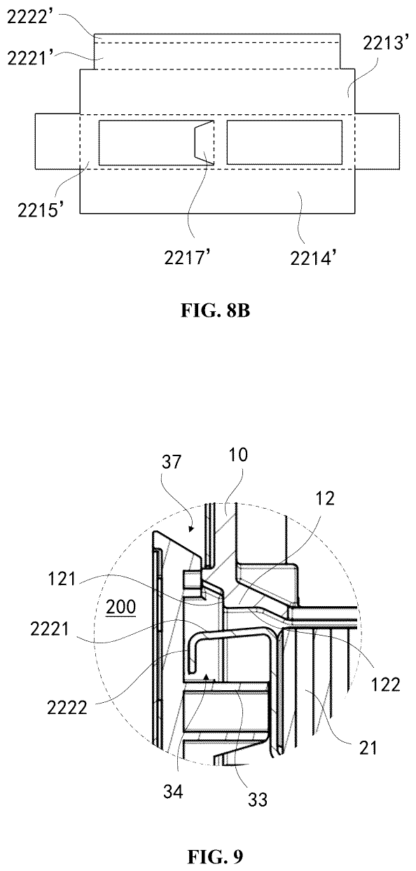

FIG. 8A diagrammatically shows a perspective view of the container 22 of the air duct assembly 100 according to an exemplary embodiment of the present application.

As shown in FIG. 8A, the container 22 may include a container body 221 and a container handle 222. The container body 221 has a container cavity 2211 for accommodating the filter element 21. The container handle 222 is configured in such a manner that the user can grip the container handle 222 to install in place and/or remove the filter module 20 via the insertion opening 11. Thus, in the process of the maintenance operation of the filter module 20, the user's hands can be prevented from being soiled by contacting the container body 221 or the filter element 21.

It can be seen from FIG. 7 and FIG. 8A that the container handle 222 is covered by the filter cover 30 in a direction toward the storage space 200.

The container handle 222 may extend from the container body 221 toward the storage space 200. Optionally, the container handle 222 extends at least into the opening 11 in the direction toward the storage space 200. This makes the filter module 20 easy to remove.

For example, as shown in FIG. 7, the container handle 222 may extend beyond the air duct cover 10 in the direction toward the storage space 200. This further helps to make the filter module 20 easy to remove.

FIG. 9 diagrammatically shows a partial enlarged view of the portion circled in FIG. 7.

As can be seen from FIG. 8A and FIG. 9, the container handle 222 may include a first handle section 2221 extending toward the storage space 200 and a second handle section 2222 extending downward from the first handle section 2221. An upper surface of the first handle section 2221 extends toward the storage space 200 in a downwardly inclined manner. Thus, condensed water can be prevented from flowing from a surface of the air duct cover 10 facing the storage space 200 to the filter element 21. Condensed water accumulated at the filter element 21 will reduce the filtering performance of the filter module 20. Therefore, by using such a configuration of the container handle 222, the filtering performance of the filter module 20 can be improved and the frequency of maintenance required for the filter module 20 can be reduced.

An angle by which the upper surface of the first handle section 2221 is downwardly inclined may be between 0.1° and 6°, for example 5°.

Optionally, the air duct cover 10 may be provided with a ridge 12 located at a top of the insertion opening 11 and protruding toward a bottom of the insertion opening 11. The ridge 12 may prevent the condensed water from flowing from the surface of the air duct cover 10 facing the storage space 200 to the filter module 20, in particular the filter element 21.

The ridge 12 may extend transversely to the insertion direction D_{IN} and transversely to the height direction H of the refrigerating appliance. The ridge 12 can effectively block water flow that flows toward the filter module 20, in particular the filter element 21, substantially along the insertion direction D_{IN}.

The ridge 12 has for example a front blocking surface 121 and/or a bottom blocking surface 122. The front blocking surface 121 may face toward the storage space 200 and be perpendicular to the insertion direction D_{IN}. The bottom blocking surface 122 may extend in an upwardly inclined manner from the front blocking surface 121 in a direction away from the storage space 200. The inclination angle of the bottom blocking surface 122 may be optionally between 0.1° and 5°, for example 1°. Thus, the condensed water can be prevented effectively from flowing backward toward the filter element 21 along the bottom blocking surface 122. The ridge 12 is particularly closer to the storage space 200 than the filter element 21 of the filter module 20.

In particular, the ridge 12 may be located directly above the downwardly inclined first handle section 2221. Referring to FIG. 7, even if the condensed water flows backward from the surface of the air duct cover 10 facing the storage space 200 via a gap existing between the air duct cover 10 and the filter cover 30, it can only flow downward along the front blocking surface 121 of the ridge 12, drip onto the first handle section 2221 and then flow forward along the first handle section 2221. Finally, the condensed water may flow out through the gap at the bottom between the air duct cover 10 and the filter cover 30 and will not flow to the filter module 20.

According to an exemplary embodiment of the present application, the filter cover 30 may be provided on a side facing away from the storage space 200 with a protruding reinforcement structure 33 and a receiving recess 34 recessed relative to the reinforcement structure 33. The receiving recess 34 may extend along the longitudinal direction of the filter cover 30 and be configured to receive the container handle 222.

With reference to FIG. 9, an interspace may be formed between the container handle 222 and the filter cover 30 in the insertion direction D_{IN}, for example.

Referring back to FIG. 8A, the container 22 may for example include at least two container bodies 221 and a container handle 222. Each of the respective container bodies 221 may have a respective container cavity 2211 which is separated from the container cavity 2211 of the other container body 221. The container handle 222 may be configured in such a manner that the user can grip the container handle 222 to install in place and/or remove the filter module 20 via the insertion opening 11. The container 22 may be formed by bending a single sheet. The sheet with a specific shape may be formed by a punching process and/or a cutting process. One sheet may be formed into one container 22 including the at least two container bodies 221 and the container handle 222 by a pre-configured bending step. Therefore, the container 22 has a relatively complex structure that can meet the usage requirements and can be manufactured in a cost-effective manner.

The container cavity 2211 may have a container opening 2212 which opens upwards and via which the filter element 21 can enter the container cavity 2211. The at least two container bodies 221 each include a front wall 2213 close to the filter cover 30, a rear wall 2214 opposite to the front wall 2213 in the insertion direction D_{IN} and a bottom wall 2215 connected between the front wall 2213 and the rear wall 2214 and opposite to the container opening 2212. In this embodiment, the front walls 2213 of the at least two container bodies 221 are coplanar and continuous and the rear walls 2214 of the at least two container bodies 221 are coplanar and continuous. This configuration of the container 22 can meet the usage requirements and is suitable for being bent from the single sheet.

In particular, the bottom walls 2215 of the at least two container bodies 221 may be coplanar and continuous and each of the bottom walls 2215 may have a bottom opening 2216 respectively. At least one container body 221 of the at least two container bodies 221 may include a tab 2217 bent upward from an edge of the bottom opening 2216 thereof adjacent to the adjacent container body 221. The tab 2217 may separate the container cavity 2211 of the at least one container body 221 from the container cavity 2211 of the adjacent container body 221. It provides an implementation of the container 22 which has a relatively complex structure that can meet the usage requirements and can be manufactured in a cost-effective manner.

FIG. 8B diagrammatically shows a sheet for manufacturing a container 22 in an exemplary embodiment according to the present application. The sheet can be bent along the outline shown by the broken lines. By bending, the sheet can form the container 22 as shown in FIG. 8A. In FIG. 8B, sheet portions that will serve as the front wall 2213, the rear wall 2214, the bottom wall 2215 and the tab 2217 in the container 22 are respectively marked with 2213′, 2214′, 2215′ and 2217′, and sheet portions that will serve as the first handle section 2221 and the second handle section 2222 of the container handle 222 in the container 22 are respectively marked with 2221′ and 2222′. With the structural configuration of the container 22, the sheet used to manufacture the container 22 is allowed to have a more regular shape. This helps to simplify the manufacturing process and reduce the material loss.

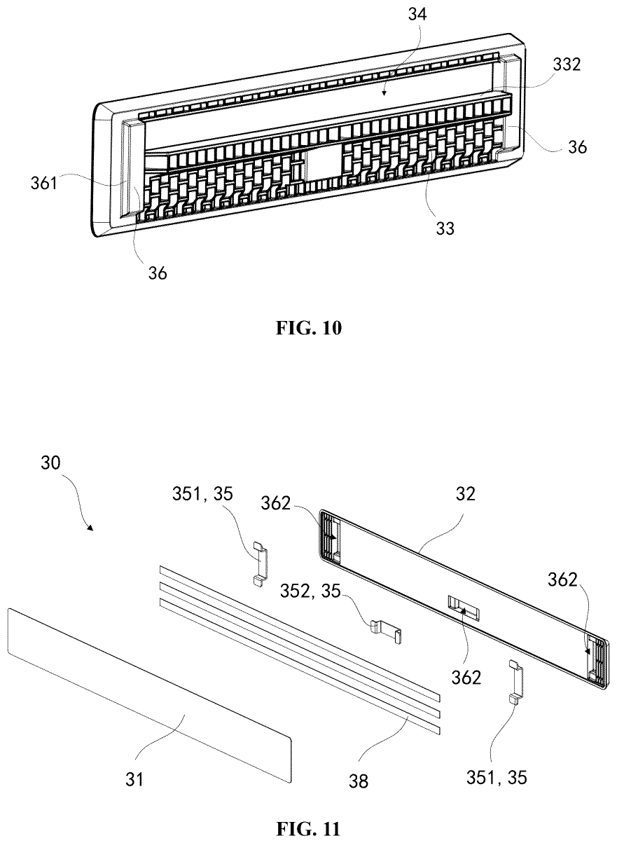

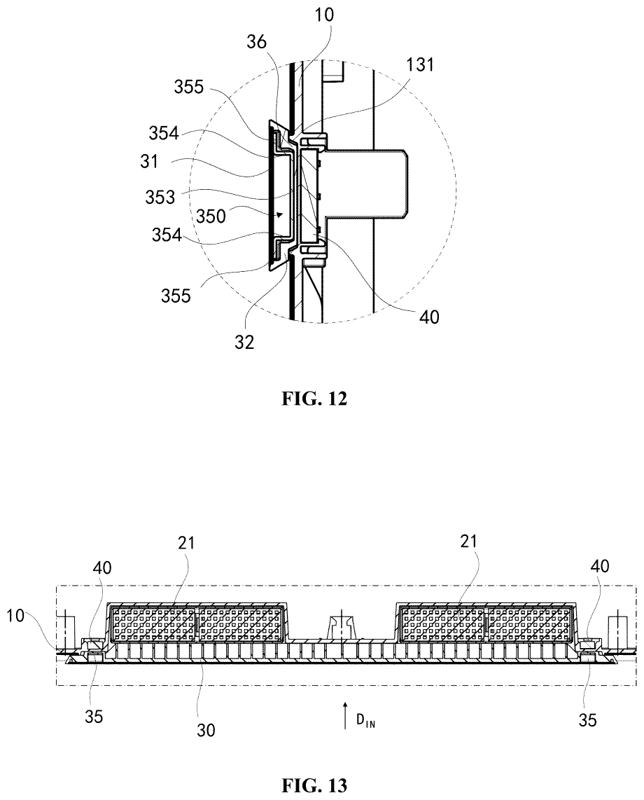

The air duct assembly 100, in particular its air duct cover 10 according to exemplary embodiments of the present application is further described below in conjunction with FIG. 10 to FIG. 13. FIG. 10 diagrammatically shows a perspective view of the air duct cover 10 of the air duct assembly 100 according to an exemplary embodiment of the present application. FIG. 11 diagrammatically shows an exploded view of the air duct cover 10. FIG. 12 and FIG. 13 diagrammatically show partial cross-sectional views of the air duct assembly 100 taken along section lines B-B and C-C in FIG. 1, respectively.

It can be seen from FIG. 10 to FIG. 13 that the filter cover 30 may be provided with at least one first magnetic member 35. The air duct assembly 100 may further include a second magnetic member 40 connected to the air duct cover 10. The filter cover 30 is attached to the air duct cover 10 by magnetic attraction between the first magnetic member 35 and the second magnetic member 40. The first magnetic member 35 and the second magnetic member 40 for example may both be formed of magnets or may respectively be formed of the magnet and metal that can be attracted by the magnet.

In the embodiment, the filter cover 30 may include the front panel 31 and the back plate 32, wherein the front panel 31 is located on the side of the back plate 32 facing the storage space 200 and forms the surface of the filter cover 30 facing the storage space 200. As an example, the filter cover 30 may also include an adhesive part 38 for bonding the front panel 31 to the back plate 32.

In particular, the first magnetic member 35 may be sandwiched between the front panel 31 and the back plate 32. It helps protect the first magnetic member 35 from moisture corrosion.

The filter cover 30 may be provided with a guide protrusion 36 on the side facing away from the storage space 200, which may have a mounting cavity 362 for mounting the first magnetic member 35 on the side facing the storage space 200. The guide protrusion 36 may have a guide side 361 which is inclined relative to the insertion direction D_{IN} in a manner that the guide protrusion 36 is narrowed along the insertion direction D_{IN}. On the one hand, the guide protrusion 36 can guide the filter cover 30 to be correctly positioned relative to the air duct cover 10 with the guide side 361 when the filter cover 30 is installed, and on the other hand, it can be used to accommodate the first magnetic member 35 and enable the first magnetic member 35 to be closer to the second magnetic member 40.

The at least one first magnetic member 35 may at least include two end magnetic members 351 located at both ends of the filter cover 30 and a middle magnetic member 352 disposed centrally relative to the filter cover 30. The end magnetic members 351 may be disposed perpendicular to the longitudinal direction of the filter cover 30. The middle magnetic member 352 may be disposed parallel to the longitudinal direction of the filter cover 30.

The filter cover 30 may be provided with a protruding reinforcing rib 332 on the side facing away from the storage space 200. The reinforcing rib 332 may extend along the longitudinal direction of the filter cover 30 between the two end magnetic members 351. The middle magnetic member 352 may be located above or below the reinforcing rib 332. Such a layout can effectively prevent the filter cover 30 from deforming. In particular, when one filter cover 30 is used to close two or more insertion openings 11, the longitudinal dimension of the filter cover 30 is large and the combination of the reinforcing rib 332, the end magnetic members 351 and the middle magnetic member 352 helps to prevent the filter cover 30 from deforming. The reinforcing rib 332 extends uninterruptedly from the front of one insertion opening 11 to the front of another insertion opening 11.

The first magnetic member 35 may have a middle section 353 close to the second magnetic member 40, two bent sections 354 extending from both ends of the middle section 353 in the direction toward the storage space 200 and two foot sections 355 extending from the ends of the two bent sections 354 away from the middle section 353 in a direction away from each other. A free space 350 is formed between the surface of the filter cover 30 facing the storage space 200 and the middle section 353. Such a configuration of the first magnetic member 35 helps to enhance the magnetic attraction effect and facilitates installation. As an example, the foot sections 355 can be adhered to the back plate 32 by an adhesive agent or an adhesive tape.

The first magnetic member 35 is for example an iron plate. Accordingly, the second magnetic member 40 may be formed by a magnet.

Along the insertion direction D_{IN}, the first magnetic member 35 may be disposed offset from the filter module 20. It facilitates exposing the filter module 20 in the air duct 300 as much as possible, so that the airflow in the air duct 300 can pass through the filter module 20 more adequately along an airflow direction perpendicular to the insertion direction D_{IN}.

When viewed along the insertion direction D_{IN}, the first magnetic members 35 may be disposed on opposite sides of the insertion opening 11. It contributes to a compact and stable structure of the air duct assembly 100.

With reference to FIG. 12 and FIG. 13, the first magnetic member 35 and the second magnetic member 40 may be disposed opposite to each other with the air duct cover 10 interposed therebetween. It helps to strengthen the magnetic attraction.

FIG. 12 also shows that the groove side 132 of the mounting groove 13 of the air duct cover 10 can be inclined relative to the insertion direction D_{IN} in such a manner that the mounting groove 13 is narrowed along the insertion direction D_{IN}. The inclined groove side 132 can be used to guide the correct installation of the filter cover 30. The inclination angle of the groove side 132 can particularly match the inclination angle of the guide side 361 of the guide protrusion 36. The groove side 132 can cooperate with the guide side 361 to guide the correct installation of the filter cover 30. In the installed state, the groove side 132 can be in surface contact with the guide side 361.

According to an exemplary embodiment of the present application, the filter cover 30 may be disposed to protrude relative to the air duct cover 10 in the direction toward the storage space 200, see FIG. 7 and FIG. 9. Thus, the filter cover 30 may be easily removed.

Optionally, at least one side of the filter cover 30 may extend obliquely toward the duct cover 10, to form a gripping space 37 between the at least one side and the surface of the duct cover 10 facing the storage space 200. The gripping space 37 may be covered by the filter cover 30 in the direction toward the storage space 200. The user's hand can enter the gripping space 37 to remove the filter cover 30. In the installed state, the gripping space 37 is not visible to the user.

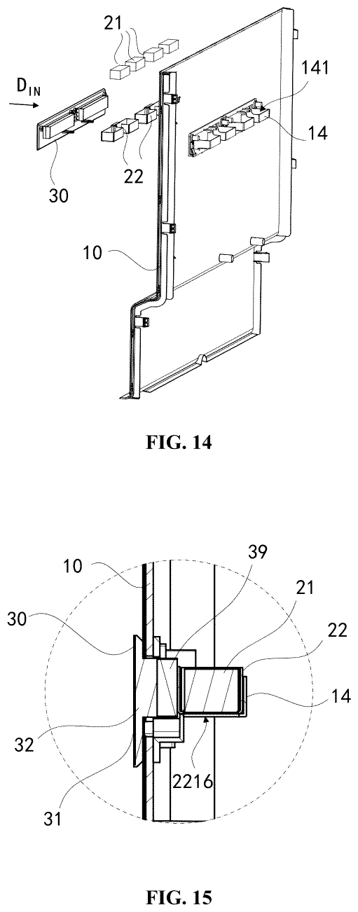

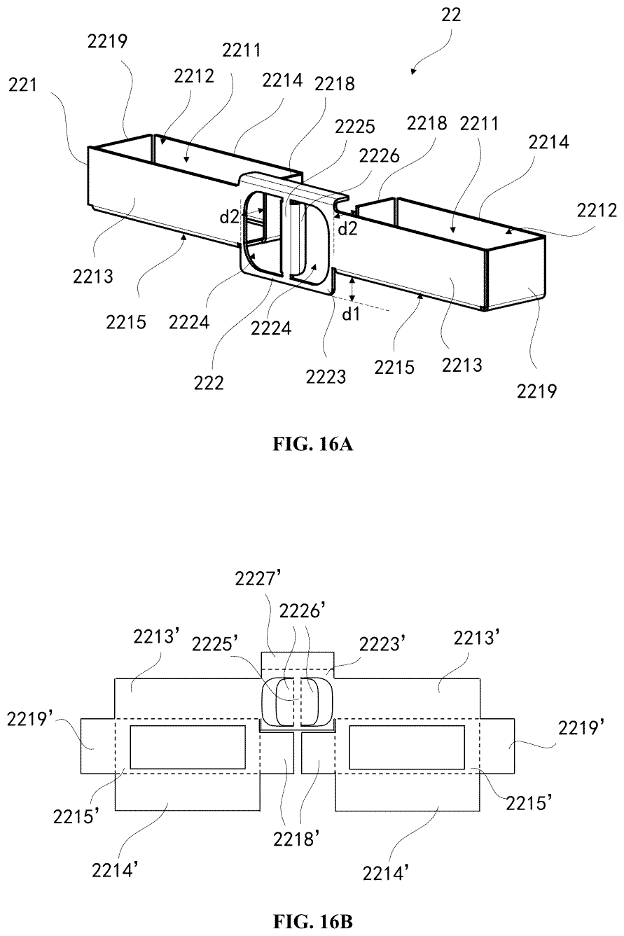

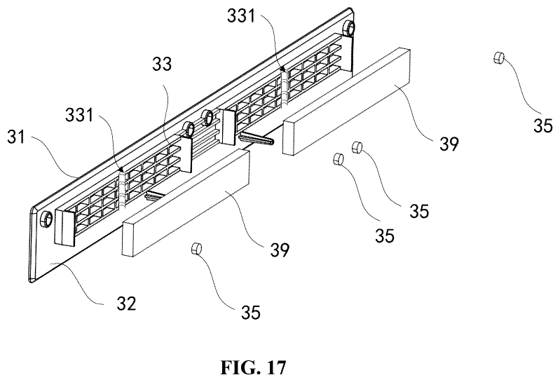

FIG. 14 diagrammatically shows an exploded view of the air duct assembly 100 according to an exemplary embodiment of the present application and FIG. 15 diagrammatically shows a partial cross-sectional view of the air duct assembly 100. FIG. 15 shows a portion of the air duct assembly 100 similarly to FIG. 7. FIG. 16A diagrammatically shows the container 22 of the air duct assembly 100. FIG. 17 diagrammatically shows an exploded view of the filter cover 30 of the air duct assembly 100.

Similar to the above-described embodiments, in this embodiment, the air duct assembly 100 includes the air duct cover 10, the filter module 20 and the filter cover 30.

The air duct cover 10 may have the support frame 14 on the side facing away from the storage space 200 and the support frame 14 defines the accommodation space 141 for the filter module 20. Here, the support frame 14 may be formed as a separate component. The support frame 14 may be mounted to the main body of the air duct cover 10 in a direction perpendicular to the insertion direction D_{IN}, for example.

The filter module 20 includes the filter element 21 and the container 22 for accommodating the filter element 21. As shown in FIG. 16A, the container 22 may include at least two container bodies 221 and one container handle 222. Each of the respective container bodies 221 has a respective container cavity 2211 which is separated from the container cavity 2211 of the other container body 221.

The container handle 222 may include a handle wall 2223 provided with at least two handle openings 2224 and a handle bar 2225 located between adjacent handle openings 2224. The container handle 222 optionally further includes a wing 2226 bent backward from an edge of the handle bar 2225 adjoining the handle opening 2224. The container handle 222 with such a shape is convenient for the user to grip and is easy to manufacture.

The container cavity 2211 has a container opening 2212 which opens upward and via which the filter element 21 can enter the container cavity 2211. The at least two container bodies 221 each include the front wall 2213 close to the filter cover 30, the rear wall 2214 opposite to the front wall 2213 in the insertion direction D_{IN} and the bottom wall 2215 connected between the front wall 2213 and the rear wall 2214 and opposite to the container opening 2212. The container 22 can in particular be formed by bending the single sheet.

The container handle 222 may be located between two adjacent container bodies 221. The handle wall 2223 of the container handle 222 is coplanar and continuous with the front walls 2213 of the two adjacent container bodies 221.

Optionally, the width of the handle wall 2223 is equal to or greater than twice the height of the two adjacent container bodies 221. It helps to reduce the material loss of the sheet used to manufacture the container 22 while meeting the usage requirements of the container 22.

In an exemplary embodiment, the handle wall 2223 may protrude downwardly by a first distance d1 relative to the front wall 2213 of the two adjacent container bodies 221. The two adjacent container bodies 221 may have an inner side wall 2218 and an outer side wall 2219 connected between the front wall 2213 and the rear wall 2214 and opposite to each other. The inner side wall 2218 is adjacent to the container handle 222 and the outer side wall 2219 is away from the container handle 222. The inner side wall 2218 of the two adjacent container bodies 221 is spaced apart from the front wall 2213 by a second distance d2 in the insertion direction D_{IN}. The second distance d2 may be equal to or greater than the first distance d1. The handle bar 2225 can have a relatively long length, making it convenient for the user to use. While ensuring that the handle bar 2225 has a relatively long length, the front wall 2213 of the container body 221 can still have a relatively small height dimension and the container 22 can still be made of the single sheet without complicating the shape of the required sheet. This is particularly helpful in reducing the material loss of the sheet used to manufacture the container 22 while meeting the usage requirements of the container 22.

Optionally, the handle wall 2223 may protrude upward relative to the front walls 2213 of the two adjacent container bodies 221. This may also allow the handle bar 2225 to have a relatively long length, making it convenient for the user to use. The container handle 222 may also include for example an edge fold 2227 that is bent backward from an upper edge of the handle wall 2223. When the containers 22 are manufactured in batches, the upwardly protruding portion of the handle wall 2223 and the edge fold 2227 will not substantially increase the area of the required sheet.

In the exemplary embodiments of the present application, the configuration of the container 22 can ensure that the container 22 has a more complex structure for meeting the usage requirements and is suitable for being bent from the single sheet. In addition, the material loss of the sheet used to manufacture the container 22 can also be reduced.

FIG. 16B diagrammatically shows the sheet used to manufacture the container 22 in an exemplary embodiment according to the present application. The sheet can be bent along the outline shown by the broken line. By bending, the sheet can form the container 22 as shown in FIG. 16A. In FIG. 16B, sheet portions that will serve as the front wall 2213, the rear wall 2214, the bottom wall 2215, the inner side wall 2218 and the outer side wall 2219 in the container 22 are respectively marked with 2213′, 2214′, 2215′, 2218′ and 2219′, and sheet portions that will serve as the handle wall 2223, the handle bar 2225, the wing 2226 and the edge fold 2227 of the container handle 222 in the container 22 are respectively marked with 2223′, 2225′, 2226′, 2227′. As can be seen from FIG. 16B, the sheet portion 2223′ and the sheet portion 2227′ of the sheet for forming the handle wall 2223 and the edge fold 2227 exceed the sheet portion 2213′ for forming the front wall 2213, which makes the shape of the sheet less regular but will not increase the material loss. Before the sheets are separated, the sheet portions 2223′ and 2227′ of one sheet can protrude between the sheet portions 2214′ of another sheet.

As shown in FIG. 17, the filter cover 30 may include the front panel 31 and the back plate 32, wherein the front panel 31 is located on the side of the back plate 32 facing the storage space 200 and forms the surface of the filter cover 30 facing the storage space 200.

The filter cover 30 may further include the first magnetic member 35, which is for example mounted to the back plate 32. The filter cover 30 may be attached to the air duct cover 10 by the magnetic attraction between the first magnetic member 35 and the second magnetic member. The second magnetic member may for example be mounted in the support frame 14. In this embodiment, the first magnetic member 35 is for example a magnet and the second magnetic member is for example made of iron.

The filter cover 30 may be provided with the protruding reinforcement structure 33 on the side facing away from the storage space 200 and the reinforcement structure 33 extends in the longitudinal direction of the filter cover 30. The reinforcement structure 33 may be provided with a drainage groove 331, which extends in the height direction H of the refrigeration appliance. Thus, even if the condensed water flows from the surface of the air duct cover 10 facing the storage space 200 via the gap between the air duct cover 10 and the filter cover 30 to the rear of the filter cover 30, it will flow downward via the drainage groove 331 and will not flow to the container 22.

Optionally, the filter cover 30 may further include a heat insulator 39. The heat insulator 39 may be made of a heat insulating material, such as a heat insulating foam. The heat insulator 39 may separate the front panel 31 and/or the back plate 32 of the filter cover 30 from the filter module 20. The heat insulator 39 may be attached to a side of the back plate 32 facing away from the storage space 200, for example.

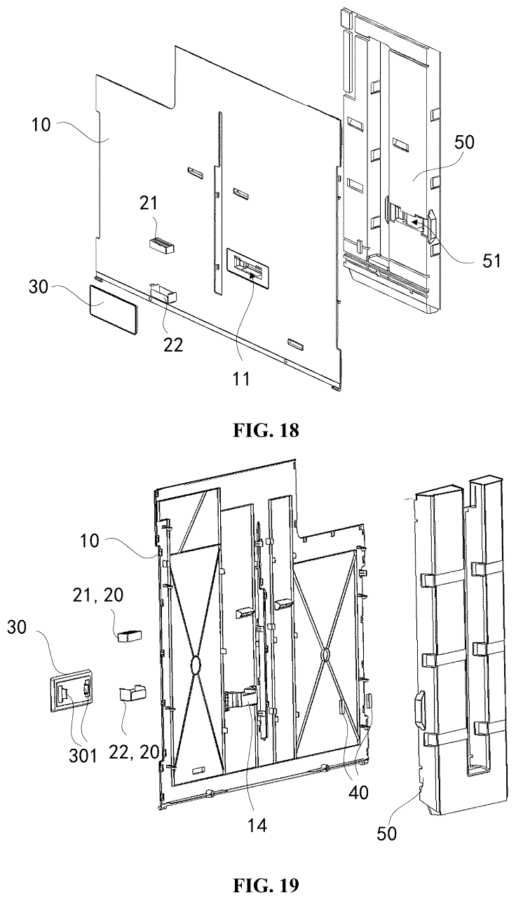

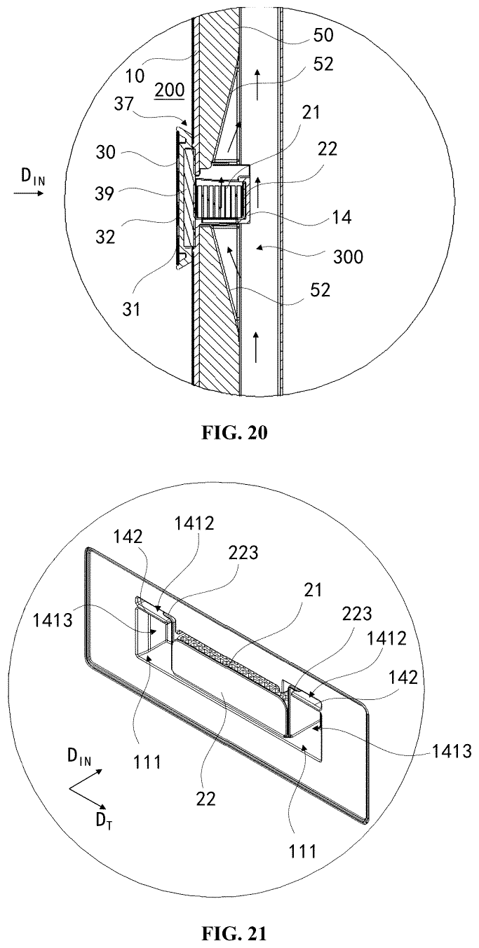

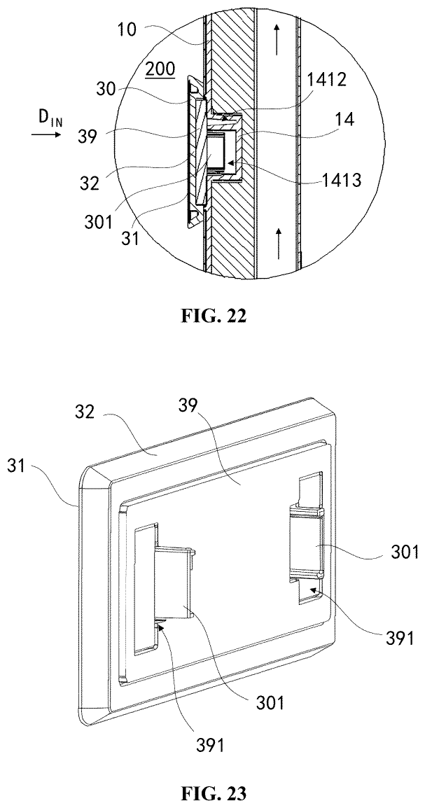

FIGS. 18 and 19 diagrammatically show exploded views of the air duct assembly 100 according to an exemplary embodiment of the present application from different perspectives. FIG. 20 diagrammatically shows a partial cross-sectional view of the air duct assembly 100, and shows a portion of the air duct assembly 100 similarly to FIGS. 7 and 15. FIG. 21 diagrammatically shows a partially enlarged view of the air duct assembly 100, in which the air duct cover 10 is not shown. FIG. 22 diagrammatically shows another partial cross-sectional view of the air duct assembly 100.

Similar to the above-described embodiments, in this embodiment, the air duct assembly 100 includes the air duct cover 10, the filter module 20 and the filter cover 30. The air duct assembly 100 may further include an air duct heat insulator 50 located between the air duct cover 10 and the air duct 300. The air duct heat insulator 50 is provided with a mounting opening 51, and the filter module 20 is at least partially located within the mounting opening 51. Such a configuration is particularly suitable for the air duct assembly 100 in which the air duct 300 is a supply air duct.

The air duct heat insulator 50 may further be provided with an air guiding surface 52 adjacent to the mounting opening 51 and facing the air duct 300. The air guiding surface 52 is inclined toward the storage space 200 in a direction toward the filter module 20. Through the use of the air guiding surface 52, more air can pass through the filter element 21. As shown in FIG. 10, such air guiding surfaces 52 may be provided both above and below the mounting opening 51.

The air duct 300 has a bypass portion on a side of the filter module 20 facing away from the storage space 200, wherein a portion of the air flow can bypass the filter module 20 through the bypass portion. Thereby, the impact of the filter module 20 on the cooling efficiency can be reduced. The filter module 20 may be disposed such that the filter element 21 substantially does not extend beyond a rear main plane of the air duct heat insulator 50 along the insertion direction D_{IN}.

As can be seen from FIGS. 18 and 21, the insertion opening 11 has transverse spaces 111 on both sides of the filter module 20 in a transverse direction DT perpendicular to the insertion direction D_{IN}, to allow users to put their hand into the transverse spaces 111 to grip the filter module 20. The transverse spaces 111 may occupy, for example, more than 10%, particularly 15%, of the width of the insertion opening 11 in the width direction of the transverse space 111. The transverse direction DT is particularly also perpendicular to the airflow direction in the air duct 300.

As shown in FIG. 20, the filter cover 30 may be provided with a retaining protrusion 301 extending in a direction away from the storage space 200. The retaining protrusion 301 may be inserted in the transverse space 111 along the insertion direction D_{IN} to retain the filter cover 30 in the transverse direction DT. Thereby, in the installed state, the transverse space 111 can cooperate with the retaining protrusion 301 to achieve the retaining function, and after the air duct cover 10 is removed, the transverse space 111 can facilitate the user to grip the filter module 20. This multi-functional transverse space 111 makes the structure more compact.

The air duct cover 10 may have a support frame 14 on a side facing away from the storage space 200 and the support frame 14 defines an accommodation space 141 for the filter module 20.

The support frame 14 may include two partitions 142 extending from both sides of the accommodation space 141 toward the middle in a transverse direction DT perpendicular to the insertion direction D_{IN} and the airflow direction, such that the accommodation space 141 is divided into a middle portion 1411 located between the two partitions 142 in the transverse direction DT, first grooves 1412 located above the partitions 142, and second grooves 1413 located below the partitions 142. Through the use of the partitions 142 that are simple and easy-to-fabricate, the accommodation space 141 can be divided into multiple portions with various functions. The middle portion 1411 can be used to receive the container body 221 and filter element 21 of the filter module 20. The first grooves 1412 can be used to retain the filter module 20. The second grooves 1413 can be used to retain the air duct cover 10. During installation, the retaining protrusion 301 extends through the transverse space 111 into the second grooves 1413 and engages with the second grooves 1413 to achieve the retaining function. The opening directions of the middle portion 1411, the first grooves 1412, and the second grooves 1413 all face toward the storage space 200.

The filter module 20 includes the filter element 21 and the container 22 for accommodating the filter element 21. As shown in FIGS. 18, 19 and 21, the container 22 may include the container body 221 and a retaining flange 223. The container body 221 has the container cavity 2211 for accommodating the filter element 21. The retaining flange 223 extends outward from both sides of the container body 221 in the transverse direction DT perpendicular to the insertion direction DIN and the airflow direction. The air duct cover 10 is provided with a first groove 1412, into which the retaining flange 223 can be inserted along the insertion direction DIN to retain the filter module 20 in the airflow direction.

As described above, as an example, the first groove 1412 may be formed in the support frame 14. However, it should be understood that the first groove 1412 may be provided in the air duct cover 10 independently of the support frame 14.

As shown in FIG. 21, a dimension of the first groove 1412 in the airflow direction may particularly decrease along the insertion direction D_{IN}. This helps to reduce the difficulty of installing the filter module 20.

The retaining flange 223 may be formed only on a rear half of the container 22 along the insertion direction D_{IN}. This also helps to reduce the difficulty of installing the filter module 20.

Optionally, the container 22 may be provided with a color-changing area that can be restored by heating. The color-changing area may change its color slowly and can restore its original color by the high-temperature treatment. The color-changing area may be provided on a side of the container body 221 facing the storage space 200.

The color-changing area may contain a material that can change color due to oxidation, such as silver. As the service time increases, the silver in the color-changing area turns black due to oxidation. This change in color reminds the user that the high-temperature treatment for the filter module 20 is required. When the filter module 20 is subjected to the high-temperature treatment, the filter module 20 can be cleaned and sterilized and its function can be restored, while the color-changing area can be restored to its original color. Then, the filter module 20 can be installed into the air duct assembly 100 again and the color-changing area can continue to function before the next maintenance operation.

The color-changing area may for example take the form of text that can be visible after the change in color so that a reminder message is shown to the user. Optionally, the color-changing area may be applied to the container 22 as a silver coating. The outline of the silver coating may be shaped like a specific text. Alternatively, the color-changing area may include a silver coating and a silver-colored covering layer covering the silver coating. The covering layer may have a hollow structure in the shape of specific text and the silver coating may be exposed through the hollow structure.

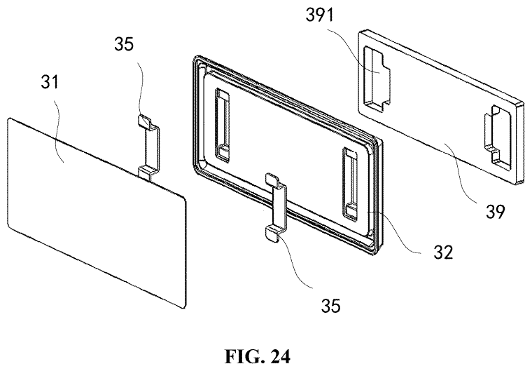

FIGS. 23 and 24 diagrammatically show a perspective view and an exploded view of the filter cover 30 of the air duct assembly 100 according to an exemplary embodiment of the present application.

The filter cover 30 may include the front panel 31 and the back plate 32. The front panel 31 is located on a side of the back plate 32 facing the storage space 200 and forms a surface of the filter cover 30 facing the storage space 200. The first magnetic member 35 may be sandwiched between the front panel 31 and the back plate 32.

The filter cover 30 may further include a heat insulator 39 located on a side of the filter cover 30 facing away from the storage space 200 and separating the filter module 20 from the storage space 200.

As shown in FIG. 22, the heat insulator 39 may abut against the air duct cover 10 and close the insertion opening 11. Thereby, the heat insulation effect can be enhanced and meanwhile condensed water can be prevented from flowing from the surface of the air duct cover 10 facing the storage space 200 to the filter element 21.

The heat insulator 39 may have a through hole 391. The retaining protrusion 301 formed on the back plate 32 may pass through the through hole 391. When viewed along the insertion direction D_{IN}, the first magnetic member 35 is also located in the area of the through hole 391.

Optionally, an upper side surface of the filter cover 30 extends obliquely toward the air duct cover 10, so that the gripping space 37 is formed between the upper side surface and the surface of the air duct cover 10 facing the storage space 200. The gripping space 37 may be covered by the filter cover 30 in a direction toward the storage space 200. A lower edge of the upper side surface may particularly extend obliquely in the transverse direction DT to avoid accumulation of condensed water on the upper side surface. The lower edge of the upper side surface may extend obliquely relative to an upper edge of the upper side surface. For example, a left end of the lower edge may be higher than a right end, which is beneficial for condensed water, that may flow into the gripping space 37, to flow down and exit the gripping space 37.

Although specific embodiments have been described above, these embodiments are not intended to limit the scope of the present disclosure, even when only a single embodiment is described with respect to specific features. The feature examples provided in the present disclosure are intended to be illustrative, but not limiting, unless otherwise stated. In specific implementations, multiple features may be combined with each other as required and as technically feasible. In particular, features in different embodiments may also be combined with each other. Various substitutions, variations and modifications may also be conceived of without departing from the spirit and scope of the present application.

The following is a summary list of reference numerals and the corresponding structure used in the above description of the invention:
100 air duct assembly
10 air duct cover
11 insertion opening
111 transverse space
12 ridge
121 front blocking surface
122 bottom blocking surface
13 mounting groove
131 groove bottom
132 groove side
14 support frame
141 accommodation space
1411 middle portion
1412 first groove
1413 second groove
20 filter module
21 filter element
22 container
221 container body
2211 container cavity
2212 container opening
2213 front wall
2214 back wall
2215 bottom wall
2216 bottom opening
2217 tab
2218 inner side wall
2219 outer side wall
222 container handle
2221 first hand section
2222 second hand section
2223 handle wall
2224 handle opening
2225 handle bar
2226 wing
2227 edge fold
223 retaining flange
30 filter cover
31 front panel
32 back plate
33 reinforcement structure
331 drainage groove
332 reinforcement rib
34 receiving recess
35 first magnetic member
351 end magnetic member
352 middle magnetic member
353 middle section
354 bending section
355 foot section
350 free space
36 guide protrusion
361 guide side
362 mounting cavity
37 gripping space
38 adhesive part
39 heat insulator
391 through hole
301 retaining protrusion
40 second magnetic member
50 air duct heat insulator
51 mounting opening
52 air guiding surface
200 storage space
300 air duct

1. An air duct assembly for a refrigeration appliance having a storage space for accommodating items to be stored and an air duct for conveying air to adjust a temperature of the storage space, the air duct assembly comprising:
an air duct cover for separating the storage space and the air duct, said air duct cover having an insertion opening;
a filter module at least partially located in the air duct for filtering air flowing through the air duct, said filter module configured to be inserted from the storage space through said insertion opening into the air duct in an insertion direction; and
a filter cover being attached to said air duct cover independently of said filter module by a magnetic connection for closing said insertion opening and allowing said filter cover to be removed from said air duct cover independently of said filter module.

2. The air duct assembly according to claim 1, wherein said filter module is at least one of:
made of a heat-resistant material able to withstand a temperature of 200° C. or more for at least 20 minutes, or
made at least partially of plastic.

3. The air duct assembly according to claim 1, wherein said filter module includes at least one of:
a filter element and a container for accommodating said filter element, said container being made of metal, or
a front panel made of metal and a back plate made of plastic, said front panel being located on a side of said back plate facing the storage space and forming a surface of said filter module facing the storage space, and said back plate separating said front panel from said filter module.

4. The air duct assembly according to claim 1, wherein said filter module includes a filter element and a container for accommodating said filter element, said container including a container body and a container handle, said the container body having a container cavity for accommodating said filter element and said container handle configured to permit a user to grip said container handle to at least one of install in place or remove said filter module through said insertion opening.

5. The air duct assembly according to claim 4, wherein said container handle is at least one of:
covered by said filter module in a direction toward the storage space, or
extended from said container body in a direction toward the storage space, or
extended at least into said insertion opening in the direction toward the storage space, or
extended beyond said air duct cover in the direction toward the storage space.

6. The air duct assembly according to claim 4, wherein said container handle includes a first handle section extending toward the storage space and a second handle section extending downward from said first handle section, and said first handle section has an upper surface extending toward the storage space in a downwardly inclined manner.

7. The air duct assembly according to claim 4, wherein said filter module at least one of:
includes a protruding reinforcement structure on a side facing away from the storage space and a receiving recess recessed relative to said reinforcement structure, said receiving recess extending in a longitudinal direction of said filter module and being configured to receive said container handle, or
defines an interspace between said container handle and said filter module in the insertion direction, or
includes a protruding reinforcement structure on a side facing away from the storage space, said reinforcement structure extending along a longitudinal direction of said filter module and having a drainage groove, said drainage groove extending along a height direction of the refrigeration appliance.

8. The air duct assembly according to claim 4, wherein said container handle includes a handle wall, said handle wall has at least two handle openings including adjacent handle openings and a handle bar located between said adjacent handle openings, and said container handle includes a wing bent backward from an edge of said handle bar adjoining said handle opening.

9. The air duct assembly according to claim 4, wherein said container includes at least two container bodies and a container handle, each of said container bodies has a respective container cavity being separated from said container cavity of another of said container bodies, said container handle is configured to permit the user to grip said container handle to at least one of install in place or remove said filter module through said insertion opening, and said container is formed of a single bent sheet.

10. The air duct assembly according to claim 9, wherein:
said container cavity has an upwardly open container opening for permitting said filter element to enter said container cavity through said container opening; and
said at least two container bodies each include a front wall close to said filter module, a rear wall opposite said front wall in the insertion direction and a bottom wall connected between said front wall and said rear wall and opposite said container opening.

11. The air duct assembly according to claim 10, wherein said bottom walls of said at least two container bodies are coplanar and continuous and each of said bottom walls has a respective bottom opening, at least one container body of said at least two container bodies includes a tab bent upward from an edge of said bottom opening adjacent to said adjacent container body, and said tab separates said container cavity of said at least one container body from said container cavity of said adjacent container body.

12. The air duct assembly according to claim 10, wherein:
said container handle is located between two adjacent container bodies and includes a handle wall having at least two handle openings and a handle bar located between adjacent handle openings, and at least one of:
said handle wall of said container handle is coplanar and continuous with said front walls of said two adjacent container bodies, or
said handle wall has a width equal to or greater than twice a height of said two adjacent container bodies, or
said handle wall protrudes downward by a first distance relative to said front wall of said two adjacent container bodies, and said two adjacent container bodies each have an inner side wall and an outer side wall connected between said front wall and said rear wall and opposite to each other, said inner side wall is adjacent to said container handle, and said outer side wall is remote from said container handle, and said inner side walls of said two adjacent container bodies are spaced apart from said front walls in the insertion direction by a second distance equal to or greater than said first distance.

13. The air duct assembly according to claim 1, wherein:
said filter module includes a filter element and a container for accommodating said filter element, said container includes a container body and a retaining flange, said container body has a container cavity for accommodating said filter element and said retaining flange extends outward from two sides of said container body in a transverse direction perpendicular to the insertion direction and an airflow direction; and
said air duct cover has a first groove for insertion of said retaining flange along the insertion direction to retain said filter module in the airflow direction, and a dimension of said first groove in the airflow direction decreases along the insertion direction.

14. The air duct assembly according to claim 1, wherein said filter module has at least one first magnetic member, a second magnetic member is connected to said air duct cover, and said filter module is attached to said air duct cover by a magnetic attraction between said at least one first magnetic member and said second magnetic member.

15. The air duct assembly according to claim 14, wherein said at least one first magnetic member is at least one of:
disposed offset from said filter module along the insertion direction, or
includes two first magnetic members disposed on opposite sides of said insertion opening as viewed along the insertion direction, or
disposed opposite said second magnetic member with said air duct cover interposed between said at least one first magnetic member and said second magnetic member.

16. The air duct assembly according to claim 14, wherein said at least one first magnetic member includes at least two end magnetic members located at two ends of said filter module and a middle magnetic member disposed centrally relative to said filter module, said end magnetic members are disposed perpendicular to a longitudinal direction of said filter module, and said middle magnetic member is disposed parallel to the longitudinal direction of said filter module.

17. The air duct assembly according to claim 16, wherein said filter module has a protruding reinforcing rib on a side facing away from the storage space, said reinforcing rib extends between said two end magnetic members along the longitudinal direction of said filter module, and said middle magnetic member is located above or below said reinforcing rib.

18. The air duct assembly according to claim 14, wherein said first magnetic member at least one of:
has a middle section in a vicinity of said second magnetic member, two bent sections extending from two ends of said middle section in a direction toward the storage space and two foot sections extending from ends of said two bent sections away from said middle section in a direction away from each other, and a free space is formed between a surface of said filter module facing the storage space and said middle section, or
is an iron plate.

19. The air duct assembly according to claim 14, wherein said filter module has a guide protrusion on a side facing away from the storage space, said guide protrusion has a mounting cavity for mounting said first magnetic member on a side facing the storage space and said guide protrusion has a guide side being inclined relative to the insertion direction, causing said guide protrusion to be narrowed along the insertion direction.

20. The air duct assembly according to claim 14, wherein said filter module includes a front panel and a back plate, said front panel is located on a side of said back plate facing the storage space and forms a surface of said filter module facing the storage space, and said first magnetic member is sandwiched between said front panel and said back plate.

21. The air duct assembly according to claim 1, wherein:
said air duct cover has a ridge located at a top of said insertion opening, said ridge protrudes toward a bottom of said insertion opening; and said ridge at least one of:
extends transversely to the insertion direction and transversely to a height direction of the refrigeration appliance, or
has a front blocking surface facing the storage space, said front blocking surface being perpendicular to the insertion direction, or
has a bottom blocking surface extending from a front blocking surface of said ridge in an upwardly inclined manner in a direction away from the storage space, and said bottom blocking surface has an inclination angle between 0.1° and 5°, or
is closer to the storage space than said filter element of said filter module.

22. The air duct assembly according to claim 1, wherein said filter module at least one of:
protrudes relative to said air duct cover in a direction toward the storage space, or
has at least one side surface extending obliquely toward said air duct cover to form a gripping space between said at least one side surface and a surface of said air duct cover facing the storage space, said gripping space being covered by said filter module in a direction toward the storage space.

23. The air duct assembly according to claim 1, wherein said air duct cover has a mounting groove on a side facing the storage space, said mounting groove includes a groove bottom face facing the storage space and a groove side face surrounding said groove bottom face, said insertion opening is formed at said groove bottom face, and said groove side face is inclined relative to the insertion direction, causing said mounting groove to be narrowed along the insertion direction.

24. The air duct assembly according to claim 1, wherein said air duct cover has a support frame on a side facing away from the storage space, said support frame defines an accommodation space for said filter module, and said filter module is configured to be installed through said insertion opening into said an accommodation space.

25. The air duct assembly according to claim 24, wherein said support frame includes two partitions extending from two sides of said accommodation space toward a middle in a transverse direction perpendicular to the insertion direction and an airflow direction, dividing said accommodation space into a middle portion located between said two partitions in a transverse direction, first grooves located above said partitions and second grooves located below said partitions.

26. The air duct assembly according to claim 1, wherein said insertion opening has transverse spaces on two sides of said filter module in a transverse direction perpendicular to the insertion direction, to allow a hand to reach into said transverse spaces to grip said filter module.

27. The air duct assembly according to claim 26, wherein said filter module has a retaining protrusion extending in a direction away from the storage space, said retaining protrusion being inserted into said transverse space to retain said filter module in the transverse direction.

28. The air duct assembly according to claim 1, wherein said filter module includes a heat insulator located on a side of said filter module facing away from the storage space, said heat insulator separating said filter module from the storage space, and said heat insulator abutting against said air duct cover and closing said insertion opening.

29. The air duct assembly according to claim 1, which further comprises:
an air duct heat insulator located between said air duct cover and the air duct, said air duct heat insulator having a mounting opening, said filter module being at least partially located in said mounting opening; and
said air duct heat insulator having an air guiding surface adjacent to said mounting opening and facing the air duct, said air guiding surface being inclined toward the storage space in a direction toward said filter module.

30. A refrigeration appliance, comprising:
a storage space for accommodating items to be stored;
an air duct for conveying air to adjust a temperature of the storage space; and
the air duct assembly according to claim 1.
